(19) United States
(12) Patent Application Publication
(10) Pub. No.: US 2006/0015323 A1
(43) Pub. Date: Jan. 19, 2006

(54) Method, apparatus, and computer program for statistical translation decoding

(76) Inventors: Raghavendra U. Udupa, New Delhi (IN); Tanveer A. Faruquie, New Delhi (IN)

Correspondence Address: Frederick W. Gibb, III;McGinn & Gibb, PLLC, Suite 304, 2568-A Riva Road, Annapolis, MD, 21401, US

(21) Appl. No.: 10/890,496

(22) Filed: Jul. 13, 2004

(51) Int. Cl. G06F 17/27

(52) U.S. Cl. 704/9

(57) ABSTRACT

Methods, apparatuses and computer program products for decoding source text in a first language to target text in a second language are disclosed. The source text is decoded into an intermediate text portion based on a fixed alignment between words in the source text and words in the intermediate text portion and an alignment between words in the source text and words in the intermediate text portion is determined. The steps of decoding the source text and determining an alignment are alternately repeated while a decoding improvement in the intermediate text portion can be obtained. Finally, the intermediate text portion is output as the target text. The step of alternately repeating the source text decoding and alignment determination steps may be repeated for each of a plurality of lengths of the intermediate text portion.

### FIELD OF THE INVENTION

The present invention relates to translation of text from a source language to a target language and more particularly to machine translation of such text.

### BACKGROUND

The advent of the information revolution and the Internet has resulted in a need for the availability of documents in different languages. This multilingualism has in turn triggered a need for machine translation systems that are easily adaptable, quicker to train, fast, reasonably accurate, and cost effective. Such systems substantially extend the reach of knowledge and information. Statistical machine translation systems, which are based on the principles of information theory and statistics, have benefited from the availability of increased electronic data storage capacity and processing power. Such translation systems can be trained for a particular language pair, thus reducing deployment time and cost, and enabling easier maintenance and optimization for specific domain or language usage.

Consider, for example, translation of text in a source language (say French sentence f) into a target language (say English sentence e). Every target language sentence may be viewed as a possible translation of a source language sentence. For each such possible target sentence e of the source sentence f, there exists a score or probability that the target sentence e is a faithful translation of source sentence f (P(e|f)). More specifically, the string e that maximizes this score is the best translation:
Best e=Max P(e|f)
Using Bayes Theorem:
Best e=Max P(f|e).P(e)

A machine translation system thus has three main components: a translation model that assigns a probability or score P(f|e) to the event when a Target String e is translated to a source string f, a language model that assigns a probability or score P(e) to a target string e, and a decoder. The decoder takes a previously unseen sentence f and attempts to determine the sentence e that maximizes P(e|f), or equivalently, maximizes P(f|e).P(e).

Decoding is a discrete optimization problem whose goal is to determine a target sentence or portion of text that optimally corresponds to a source sentence or portion of text. The decoding problem is known to belong to a class of problems popularly known as NP-hard problems. NP-hard problems are computationally difficult and solutions thereof elude polynomial time algorithms.

In the decoding problem, it is required to find the most probable translation of a given portion of text in a source language. The language and translation models are also given. Thus, decoding represents a combinatorial search problem whose search space is prohibitively large. The challenge is in devising a scheme for efficiently searching the solution space for a solution.

Conventional decoders are primarily concerned with providing a solution under real world constraints such as limited memory, processing power and time. Consequently, speed and/or accuracy of decoding is/are compromised. Since the space of possible translated sentences or text portions is extremely large, conventional decoders typically examine only a portion of that space and thus risk missing good solutions.

Decoding time is generally a function of sentence or text length and conventional decoders are frequently unable to translate sentences of relatively longer length in a satisfactory amount of time. Whilst speed of decoding is of particular importance to real-time translation applications such as web page translation, bulk document translation, real time speech to speech translation systems, etc., accuracy of decoding is of prime importance in applications such as the translation of government documents and technical manuals.

U.S. Pat. No. 5,991,710, entitled “Method and System for Natural Language Translation”, issued to Brown, P. F., et al. on Dec. 19, 1995, relates to statistical translation methods and systems and more particularly to translation and language models for use by a decoder. Assigned to International Business Machines Corporation, the subject matter disclosed in U.S. Pat. No. 5,991,710 is incorporated herein by reference.

Yang, Y., and Waibel, A., in a paper entitled “Decoding Algorithm in Statistical Machine Translation”, published in the Proceedings of the 35th Annual Meeting of the Association for Computational Linguistics (ACL), Madrid, Spain, July 1997, describe a stack decoding algorithm for statistical translation.

Tillmann, C., Vogel, S., Ney, H., and Zubiaga, A., in a paper entitled “A DP based Search Using Monotone Alignments in Statistical Translation”, published in the Proceedings of 35th Annual Meeting of the Association for Computational Linguistics (ACL), Madrid, Spain, July 1997, describe a search algorithm for statistical translation based on dynamic programming.

Ulrich, G., et. al., in a paper entitled “Fast Decoding and Optimal Decoding for Machine Translation”, published in the Proceedings of 39th Annual Meeting of the Association for Computational Linguistics (ACL), Toulouse, France, 2001, compare the speed and output quality of a stack decoder with a fast greedy decoder and a slow but optimal decoder that treats decoding as an integer-programming optimization problem.

The stack and integer programming decoders are slow and are thus not particularly useful for applications that require fast translation. The greedy decoder, on the other hand, is fast but compromises on accuracy. Dynamic programming, while fast, suffers from a monotonicity constraint.

A need thus exists for a translation means or decoder that performs well in terms of both speed and accuracy. A need also exists for a decoder that can translate relatively long sentences in real time with a satisfactory degree of accuracy.

### SUMMARY

Aspects of the present invention provide a method, an apparatus and a computer program product for decoding source text in a first language to target text in a second language. The source text is decoded into an intermediate text portion based on a fixed alignment between words in the source text and words in the intermediate text portion and an alignment between words in the source text and words in the intermediate text portion is determined. The steps of decoding the source text and determining an alignment are alternately repeated while a decoding improvement in the intermediate text portion can be obtained. Finally, the intermediate text portion is output as the target text. The step of alternately repeating the source text decoding and alignment determination steps may be repeated for each of a plurality of lengths of the intermediate text portion.

Decoding may initially be performed based on an initial alignment that maps words in the source text to word positions in the intermediate text portion.

The decoded text may comprise an optimal translation for a fixed alignment, which may be generated based on dynamic programming.

The alignment may comprise an optimal alignment but may alternatively comprise an improved alignment relative to a previous alignment.

Aspects of the present invention also provide a method, an apparatus and a computer program product method for translating source text in a first language to translated text in a second language. An alignment between words in the source text and positions of words in the translated text is determined and an optimal translation of the source text is generated based on the alignment. The alignment and translation are performed repeatedly for each of a plurality of lengths of the translated text.

### BRIEF DESCRIPTION OF THE DRAWINGS

A small number of embodiments are described hereinafter, by way of example only, with reference to the accompanying drawings in which:

FIG. 1 is a flow diagram of message translation and recovery based on the source-channel paradigm of communication theory;

FIG. 2 is a flow diagram of a method for translating sentences in a source language (e.g., French) into sentences in a target language (e.g., English);

FIG. 3 is a flow diagram of a method for decoding a French sentence f into a corresponding English sentence e;

FIG. 4 is a flow diagram of a method for decoding a source language sentence f into a target language sentence ê;

FIG. 5 is a flow diagram of another method for decoding a source language sentence f into a target language sentence ê;

FIG. 6 is a flow diagram of another method for decoding a source language sentence f into a target language sentence e⁽⁰⁾;

FIG. 7 is a flow diagram of another method for decoding a source language sentence f into a target language sentence e⁽⁰⁾;

FIG. 8 is a graph showing a comparison of average decoding times for embodiments of decoding methods;

FIG. 9 is a flow diagram of a general method for decoding source language text into target language text; and

FIG. 10 is a flow diagram of another general method for decoding source language text into target language text; and

FIG. 11 is a block diagram of a computer system with which embodiments of the present invention may be practiced.

### DETAILED DESCRIPTION

Embodiments of methods, apparatuses and computer program products are described herein for statistical translation decoding of text from a source language into a target language. The embodiments described relate to translation of French into English. However, it is not intended that the present invention be limited in this manner as the principles of the present invention have general applicability to translation between other source and target languages. Embodiments of the invention may also perform translation of portions of text other than sentences such as paragraphs, pages and n-grams.

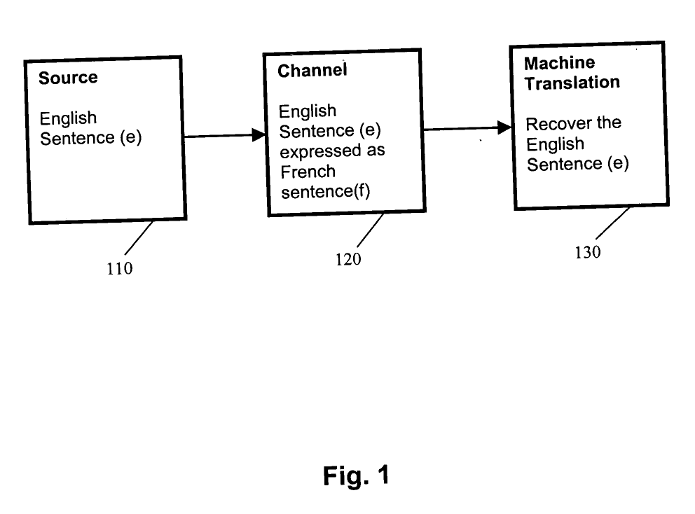

FIG. 1 is a flow diagram showing a formalism of statistical translation for message translation and recovery based on the source-channel paradigm of communication theory. Sentences conceptualized in a first language and spoken out in a second language (translation) can be thought of as sentences generated by a source 110 in the first language and input to a communication channel 120 as source messages for transmission. At step 120, a sentence (source message) is translated (corrupted) by the communication channel into a sentence in the second language. The sentence in the first language is partially or fully recovered or decoded from the sentence in the second language at step 130 by the statistical translation system.

### Embodiment of French to English Translation Decoder

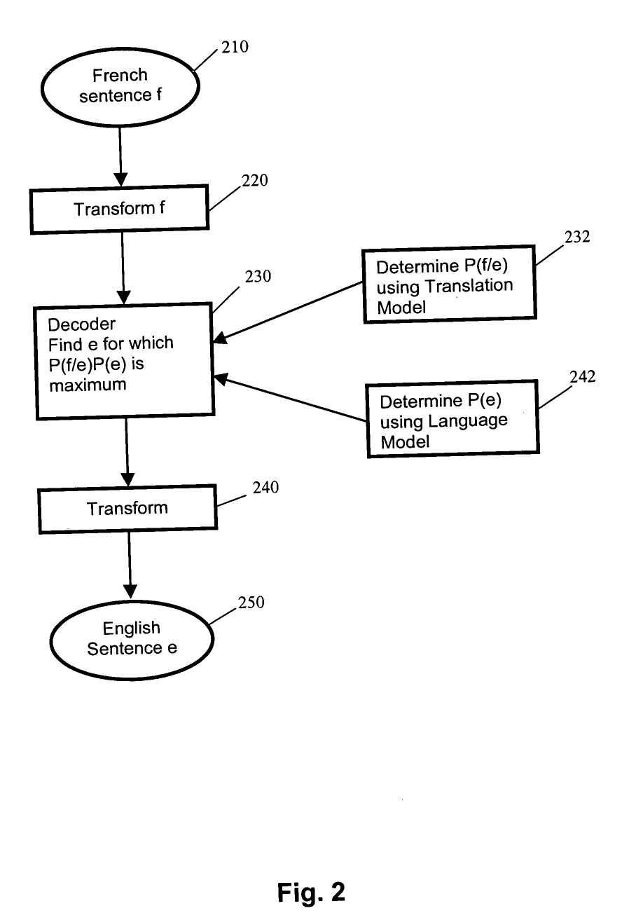

FIG. 2 is a flow diagram of a method for translating sentences in a source language (e.g., French) to sentences in a target language (e.g., English). At step 220, an optional transformation is performed on a French sentence f to facilitate the task of statistical translation. Specifically, the transformation may be used to encode global linguistic information about the language locally into the sentence. Parts of speech tagging or stemming and morphing are examples of such transformation. At step 230, a decoder is used to find a target English sentence e, which maximizes the product P(f|e)P(e). A translation model is used to determine P(f|e) at sub-step 232 and a language model is used to determine P(e) at sub-step 234. Another transformation is optionally performed at step 240, which is the inverse of the transformation step 220 to transform the sentences generated by step 230 into a usual grammatical English sentence. Examples include removing parts of speech tags and de-stemming and de-morphing the decoded sentences.

### Estimating the Translation Probability P(f|e) and the Language Probability P(e)

Conceptually, the translation model comprises a table of probability scores P(f|e) that are indicative of the degree of association of every possible pair of English and French sentences <e, f> and the language model comprises a table of probability scores P(e) for every possible English sentence e. Construction of the tables is difficult, at least on account of the number of conceivable sentences in any language being substantially large. Approximations are used in generating the probability tables and the search problem is thus a decoding problem to determine an optimal English sentence e given a novel French sentence f. Determination of the optimal English sentence is computationally hard and requires efficient and accurate search techniques.

### Searching for a Sentence e that Maximises the Product P(f|e)P(e)

Suppose that a French sentence f has |f| words denoted by f₁, f₂, . . . , fⱼ, . . , f_{|f|} and a corresponding English sentence e has |e| words denoted by e₁, e₂, . . . eᵢ, . . . , e_{|e|}. Although a word-by-word translation is insufficient for complete and accurate translation of the sentence f to the sentence e, a relationship nonetheless exists between the individual words of the two sentences. Such a relationship is known as an alignment. The alignment between the individual words of sentences f and e is denoted by a which is a tuple of order |f|. The individual elements of the tuple α₁, α₂, . . . , αⱼ, . . . , α_{|f|} are integers in the range of 1 to |e|, each of which denote which French word f an English word e is aligned to. Each French word f is aligned to exactly one English word. Numerous possible alignments are possible and, given the above model, the fundamental probability is the joint probability distribution P(e,a|f), where the alignment a is hidden. Such a model comprises of individual word-to-word translation probabilities, the alignment probabilities and the language model probabilities. When two or more French words align to a single English word, the number of French words generated by the single English word is known as the fertility of the word. Each English word has a fertility probability associated with it, which provides an indication of how many French words that particular English word may correspond to.

The decoding problem may be defined as one of finding the most probable translation ê in English (target language) of a given French (source language) sentence f in accordance with the fundamental equation of Statistical Machine Translation:
ê=argmaxₑ Pr(f|e)Pr(e) (1)

Rewriting the translation model Pr(f|e) as Σₐ Pr(f,a|e), where a denotes an alignment between the source sentence and the target sentence, the decoding problem can be restated as:
ê=argmaxₑ Σₐ Pr(f,a|e)Pr(e) (2)

Even when the translation model is as simple as the IBM Model 1 and the language model Pr(e) is a bigram language model, the decoding problem is NP-hard. IBM models 1 to 5 relate to statistical translation models, as described in U.S. Pat. No. 5,477,451, the subject matter of which is incorporated herein by reference. Practical solutions to equation 2 focus on finding sub-optimal solutions. However, a relatively simpler equation may be obtained by relaxing equation 2:
(ê, â)=argmax_{(e,a)}Pr(f,a|e)Pr(e) (3)

Solving equation 3 is a joint optimization problem in that a pair (ê, â) is searched for.

Two basic observations are particularly relevant for devising a solution for equation 3. The first observation is that given a target length l and an alignment ã that maps source words to target positions, it is simple to compute the optimal target sentence ê. For reference purposes, this procedure is known as FIXED_ALIGNMENT_DECODING. The optimal solution for FIXED_ALIGNMENT_DECODING can be computed in O(m) time for IBM models 1 to 5 using dynamic programming.

The second observation is that for a given target sentence \tilde{e}, it is simple to compute an improved or optimal alignment â that maps the source words to the target words:
\hat{a}=argmaxₐPr(f,a|\tilde{e}) (4)

The optimal alignment between the source and target sentences can be determined using the Viterbi algorithm, which is well known and comprehensively described in the literature. For IBM models 1 and 2, the Viterbi alignment can be computed using a straightforward algorithm in O(ml) time. For higher models, an approximate Viterbi alignment can be computed by an iterative local search procedure, which searches in the neighbourhood of the current best alignment for a better alignment. The first iteration can begin with any arbitrary alignment (e.g., the Viterbi alignment of IBM Model 2). It is possible to implement one iteration of local search in O(ml) time. Typically, the number of iterations is bounded in practice by O(m) and the local search therefore takes O(m²l) time. However, the methods, apparatuses and computer program products described herein do not specifically require computation of an optimal alignment. Any alignment that improves the current alignment can be used. It is straightforward to identify such an alignment using restricted swaps and moves in O(m) time. For reference purposes, the term ‘Viterbi’ is used to denote any linear time algorithm for computing an improved alignment between a source sentence and an associated translation.

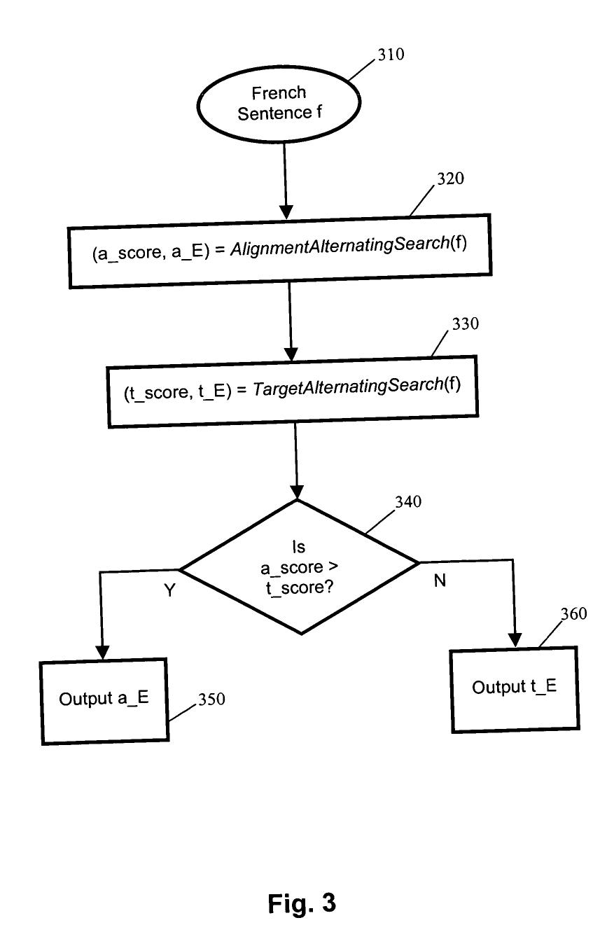

FIG. 3 is a flow diagram of a method for decoding a French sentence f into a corresponding English sentence e, which may be practiced to perform step 230 of FIG. 2.

At step 320, the French sentence f provided in step 310 is decoded into an English sentence e using an Alignment Alternating Search decoding method that returns the translated English sentence a_E, and a score a_score associated with the translated English sentence a_E. The Alignment Alternating Search decoding method iteratively improves an initial estimate of the alignment a_E.

At step 330, the French sentence f provided in step 310 is decoded into an English sentence e using a TargetAlternatingSearch decoding method that returns the translated English sentence t_E, and a score t_score associated with the translated English sentence t_E. The TargetAlternatingSearch decoding method iteratively improves an initial estimate of the target sentence t_E.

At step 340, a determination is made whether the score a_score returned by the AlignmentAlternatingSearch decoding method is higher than the score t_score returned by the TargetAlternatingSearch decoding method. If a_score>t_score (Y), the translated English sentence a_E is output as the better translation at step 340. Otherwise (N), the translated English sentence t_E is output as the better translation at step 350.

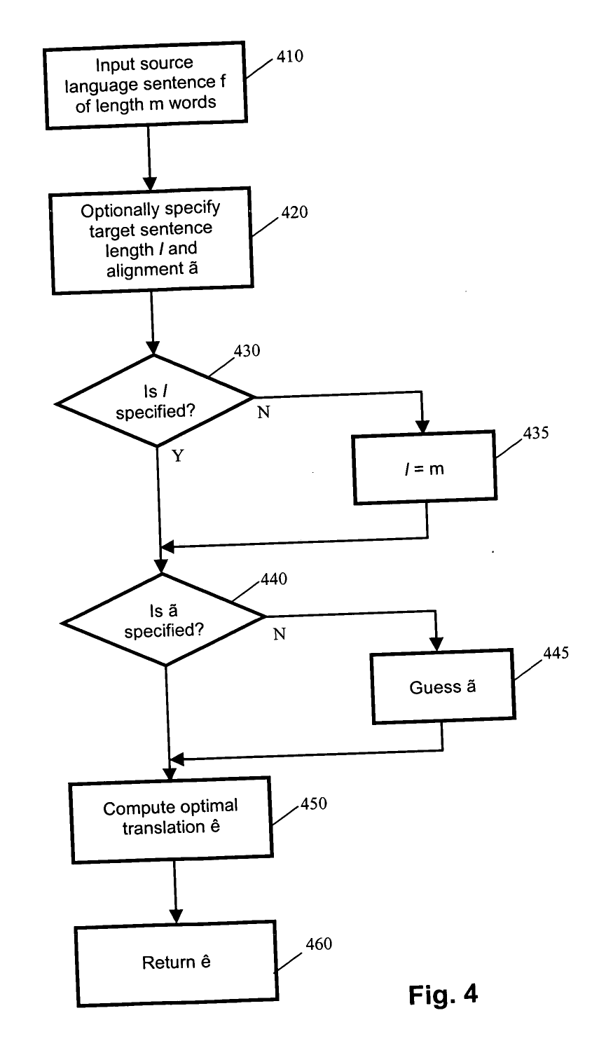

FIG. 4 is a flow diagram of a method for decoding a source language sentence f into a target language sentence ê. For reference purposes, an algorithm for practicing the method of FIG. 4 is known as NaiveDecode.

A source sentence f of length m words (m>0) is input at step 410.

The length l and alignment ã of the target sentence may optionally be specified at step 420. A determination is made at step 430 whether the length l of the target sentence ê is specified. If not (N), the length l of the target sentence ê is assumed to be the same as the length m of the source sentence f at step 435. In either case, processing continues at step 440. A determination is made at step 440 whether the alignment ã between the source sentence f and the target sentence ê is specified. If not (N), an alignment ã between the source sentence f and the target sentence ê is guessed at step 745. The alignment ã may represent a trivial alignment that maps the source word fⱼ to target position j (i.e., ãⱼ=j) or may be guessed more intelligently. In either case, processsing continues at step 450.

At step 450, an optimal translation e of the source sentence f is computed with the length l of the target sentence and the alignment ã between the source and target sentences kept fixed. The optimal translation ê is computed by maximising Pr(f,ã|e)Pr(e), that is by solving the equation: ê=argmaxₑPr(f,ã|e)Pr(e) for the fixed alignment (i.e., by solving FIXED_ALIGNMENT_DECODING using the dynamic programming technique described hereinafter).

The optimal translation ê is returned at step 460. As the above equation for fixed alignment decoding can be solved in O(m) time, the method of FIG. 4 takes O(m) time.

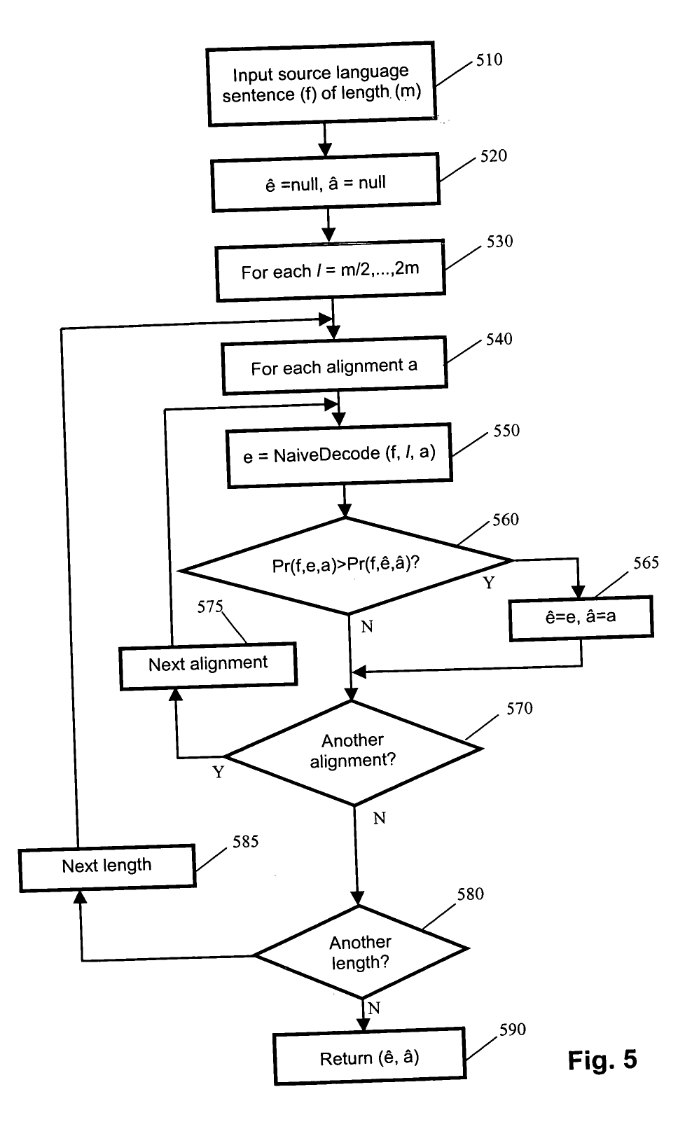

FIG. 5 is a flow diagram of another method for decoding a source language sentence f into a target language sentence ê. For reference purposes, an algorithm for practicing the method of FIG. 5 is known as NaiveOptimalDecode.

A source sentence f of length m words (m>0) is input at step 510.

The optimal target language sentence ê and alignment ã between the source sentence f and target sentence ê are initialized to null at step 520.

At step 530, a processing loop variable l, which corresponds to the length of the target sentence ê, is initialized for execution of steps 540 to 585 for each value of l from m/2 to 2m, where m is the length of the source sentence f. Other ranges of sentence length may alternatively be selected, however, a range of target sentence length from m/2 to 2m will likely be appropriate in most cases.

At step 540, a processing loop variable a is initialized for execution of steps 550 to 575 for each alignment between the source sentence f and the target sentence ê.

At step 550, a target sentence e is computed using the linear time NaiveDecode algorithm described in FIG. 4. The source sentence f, the length l and an alignment are passed to NaiveDecode, which returns a target sentence e.

At step 560, a determination is made whether the target sentence e returned in step 550 is better than the stored best translation ê. If so (Y), the stored best translation ê and the associated alignment â are updated. In either case, processing continues at step 570.

If there is another alignment to process (Y), at step 570, the next alignment is loaded at step 575 and processing returns to step 550 according to the processing loop initiated in step 540. If there are no more alignments to process (N), at step 570, processing continues at step 580.

If there is another length to process (Y), at step 580, the next length is loaded at step 585 and processing returns to step 540 according to the processing loop initiated in step 530. If there are no more lengths to process (N), at step 580, the optimal translation ê and associated alignment are returned at step 590.

The NaiveOptimalDecode algorithm of FIG. 5 considers various target lengths and all possible alignments between the source words and the target positions. For each target length l and alignment a, NaiveOptimalDecode employs NaiveDecode to identify the best solution. There are (l+1)^{m} candidate alignments for a target length l and O(m) candidate target lengths. Thus, NaiveOptimalDecode explores θ(m(l+1)^{m}) alignments. For each of those candidate alignments, NaiveOptimalDecode makes a call to NaiveDecode. The time complexity of NaiveOptimalDecode is thus O(m²(l+1)^{m}), which corresponds to exponential time.

NaiveDecode is a linear time decoding algorithm that can be used to compute a sub-optimal solution for equation 3 (the relaxed version of equation 2), whereas NaiveOptimalDecode is an exponential time decoding algorithm that can be used to compute the optimal solution. It is thus desirable to obtain an algorithm or method that is close to NaiveDecode in complexity but close to NaiveOptimalDecode in quality. The complexity of NaiveOptimalDecode may be reduced by carefully reducing the number of alignments that are examined. For example, if only a small number g(m) of alignments in NaiveOptimalDecode are examined, a solution may be found in O(mg(m)) time.

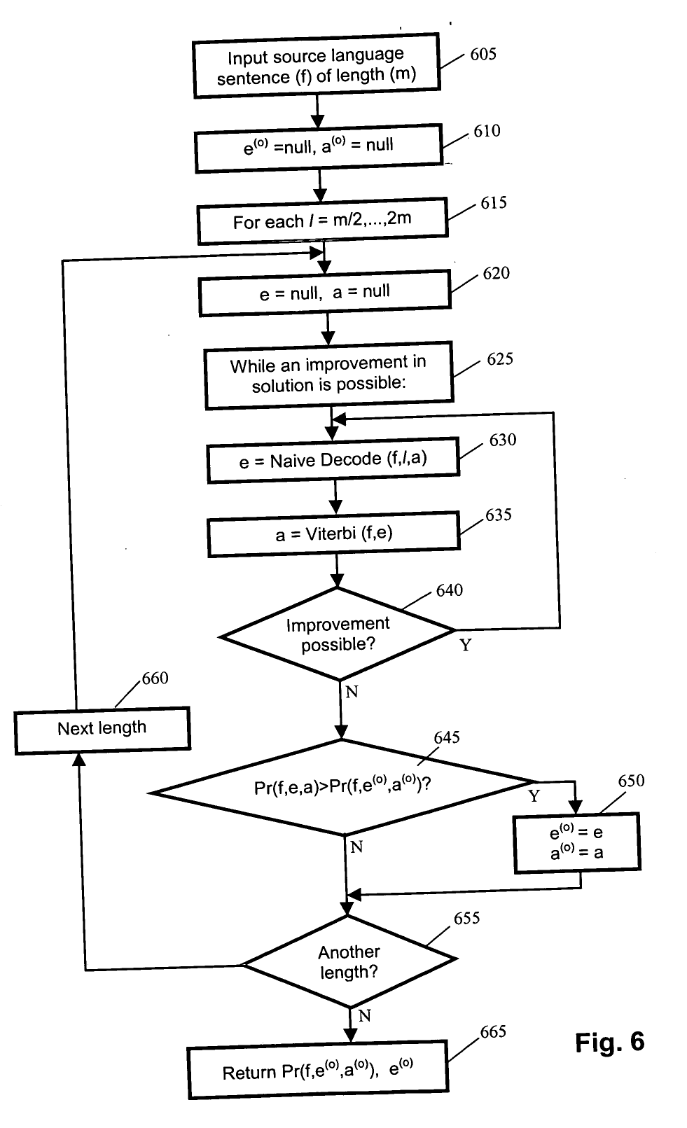

FIG. 6 is a flow diagram of another method for decoding a source language sentence f into a target language sentence e⁽⁰⁾. For reference purposes, an algorithm for practicing the method of FIG. 6 is known as AlignmentAlternatingSearch. AlignmentAlternatingSearch alternates between finding the best translation for a given alignment and finding the best alignment for a given translation. On account of being complementary, the two sub-problems are alternately used to improve the solution computed by the other.

A source sentence f of length m words (m>0) is input at step 605.

The optimal target language sentence e⁽⁰⁾ and the alignment a⁽⁰⁾ between the source sentence f and target sentence e⁽⁰⁾ are initialized to null at step 610.

At step 615, a processing loop variable l, which corresponds to the length of the target sentence e⁽⁰⁾, is initialized for execution of steps 620 to 660 for each value of l from m/2 to 2m, where m is the length of the source sentence f. Other ranges of sentence length may alternatively be selected, however, a range of target sentence length from m/2 to 2m will likely be appropriate in most cases.

At step 620, the variables e and a are initialized to null.

At step 625, an initial alignment is guessed from the source French sentence. The initial alignment can be trivially determined, say by mapping each word in the source French sentence f to a word position in the target sentence e, or can be guessed more intelligently. A processing loop is also initialized for execution of steps 630 to 640 while an improvement in the current solution is possible.

At step 630, a target sentence e is computed using the linear time NaiveDecode algorithm described in FIG. 4. The source sentence f, the length l and an alignment a are passed to NaiveDecode, which returns a target sentence e.

At step 635, an improved alignment for the target sentence e computed in step 630 is computed using the Viterbi algorithm. The source sentence f and the target sentence e are passed to the Viterbi algorithm, which returns an improved alignment a.

At step 640, a determination is made whether a further improvement in the target sentence e is possible. For example, a determination may be made whether the score for the current target sentence is better than the previous score by a sufficient amount.

If an improvement is possible (Y), processing returns to step 630 according to the processing loop initiated in step 625. If an improvement is not possible or is not of sufficient magnitude (N), step 645 determines whether the current translation is better than the previously stored best translation. If a better translation (Y), the current target sentence e and associated alignment a are stored as the optimal target sentence e⁽⁰⁾ and associated alignment a⁽⁰⁾, respectively, at step 650.

If there is another length to process (Y), at step 655, the next length is loaded at step 660 and processing returns to step 620 according to the processing loop initiated in step 615. If there are no more lengths to process (N), at step 655, the optimal translation e⁽⁰⁾ is returned at step 665.

AlignmentAlternatingSearch searches for a good translation by varying the length of the target sentence. For a sentence length l, the algorithm finds a translation of length l and then iteratively improves the translation. In each iteration, the algorithm solves two subproblems: FIXED_ALIGNMENT_DECODING and VITERBI_ALIGNMENT. The inputs to each iteration are the source sentence f, the target sentence length l, and an alignment a between the source and target sentences. Thus, AlignmentAlternatingSearch finds a better translation e for f by solving FIXED_ALIGNMENT_DECODING using NaiveDecode. Having computed e, the algorithm computes a better alignment (â) between e and f by solving VITERBI_ALIGNMENT using the Viterbi algorithm. The new alignment thus found is used by AlignmentAlternatingSearch in the subsequent iteration. At the end of each iteration, AlignmentAlternatingSearch checks whether it has made process and ultimately returns the best translation of the source f and its score across a range of target sentence lengths.

The analysis of AlignmentAlternatingSearch is complicated by the fact that the number of iterations depends on the input (i.e., NaiveDecode and Viterbi are repeatedly executed while an improvement in the solution is possible). It is reasonable to assume that the length of the source sentence (m) is an upper bound on the number of iterations. In practice, however, the number of iterations is typically O(l). There are 3m/2 candidate sentence lengths for the translation (l varies from m/2 to 2m) and both NaiveDecode and Viterbi are O(m). therefore, the time complexity of AlignmentAlternatingSearch is O(m²).

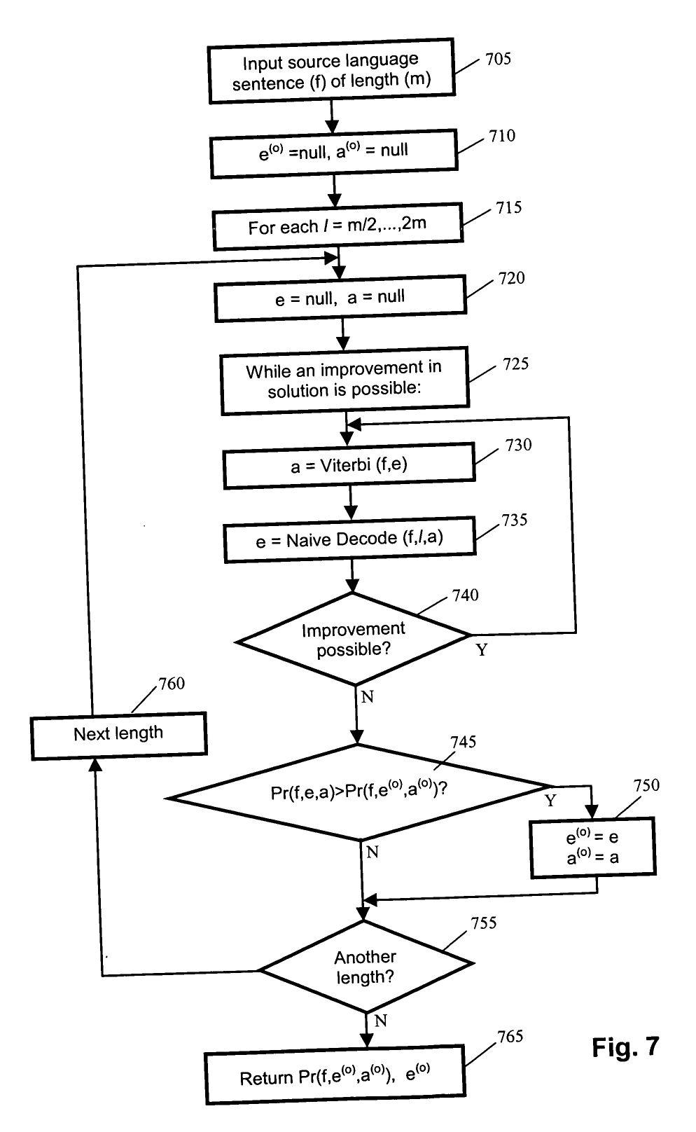

FIG. 7 is a flow diagram of another method for decoding a source language sentence f into a target language sentence e⁽⁰⁾. For reference purposes, an algorithm for practicing the method of FIG. 7 is known as TargetAlternatingSearch. TargetAlternatingSearch alternates between finding the best alignment for a given translation and finding the best translation for a given alignment. On account of being complementary, the two sub-problems are alternately used to improve the solution computed by the other.

A source sentence f of length m words (m>0) is input at step 705.

The optimal target language sentence e⁽⁰⁾ and the alignment a⁽⁰⁾ between the source sentence f and target sentence e⁽⁰⁾ are initialized to null at step 710.

At step 715, a processing loop variable l, which corresponds to the length of the target sentence e⁽⁰⁾, is initialized for execution of steps 720 to 760 for each value of l from m/2 to 2m, where m is the length of the source sentence f. A different range for target sentence may be selected if appropriate, as described hereinbefore.

At step 720, the variables e and a are initialized to null.

At step 725, an initial target sentence is guessed from the source French sentence. The initial sentence can be determined, say by picking the best target English word translation for each source word in the French source sentence or can be guessed more intelligently. A processing loop is also initialized for execution of steps 730 to 740 while an improvement in the current solution is possible.

At step 730, we solve the VITERBI_DECODING problem where an improved alignment for the target sentence e is computed using the viterbi algorithm. At step 735, we perform FIXED_ALIGNMENT_DECODING where the source sentence f, the length l and an alignment a are passed to NaiveDecode, which returns a target sentence e.

At step 740, a determination is made whether a further improvement in the target sentence e is possible. This improvement can be determined for example by seeing whether the score for the current target sentence is better than the previous score by a sufficient amount.

If an improvement is possible (Y), processing returns to step 730 according to the processing loop initiated in step 725. If an improvement is not possible or is not of sufficient magnitude (N), step 745 determines whether the current translation is better than the previously stored best translation. If a better translation (Y), the current target sentence e and associated alignment a are stored as the optimal target sentence e⁽⁰⁾ and associated alignment a⁽⁰⁾, respectively, at step 750.

If there is another length to process (Y), at step 755, the next length is loaded at step 760 and processing returns to step 720 according to the processing loop initiated in step 715. If there are no more lengths to process (N), at step 755, the optimal translation e⁽⁰⁾ is returned at step 765.

TargetAlternatingSearch searches for a good translation by varying the length of the target sentence. For a sentence length l, the algorithm finds a translation of length l and then iteratively improves the translation. In each iteration, the algorithm solves two subproblems: FIXED_ALIGNMENT_DECODING and VITERBI_ALIGNMENT. The inputs to each iteration are the source sentence f, the target sentence length l, and an alignment a between the source and target sentences. Thus, TargetAlternatingSearch finds a better translation e for f by solving FIXED_ALIGNMENT_DECODING using NaiveDecode. Having computed e, the algorithm computes a better alignment (â) between e and f by solving VITERBI_ALIGNMENT using the Viterbi algorithm. The new alignment thus found is used by TargetAlternatingSearch in the subsequent iteration. At the end of each iteration, TargetAlternatingSearch checks whether it has made process and ultimately returns the best translation of the source f and its score across a range of target sentence lengths.

The AlignmentAlternatingSearch and TargetAlternatingSearch decoding methods described in FIGS. 6 and 7, respectively, alternately produce intermediate solutions that comprise an optimal alignment and an optimal target sentence, respectively. The difference between the methods described in FIGS. 6 and 7 lies in initialization. The alignment decoding method of FIG. 6 initially guesses an alignment and then proceeds to alternate between generating an optimal target sentence and generating an optimal alignment for that optimal target sentence. The target decoding method of FIG. 7 initially guesses a target sentence and then proceeds to alternate between generating an optimal alignment for a current target sentence and generating a new optimal target sentence.

Fixed Alignment Decoding

Each of NaiveDecode, NaiveOptimalDecode, TargetAlternatingSearch and AlignmentAlternatingSearch use a linear time algorithm FIXED_ALIGNMENT_DECODING, which finds the optimal translation given the length l of the target sentence and the alignment â that maps source words to target positions. A dynamic programming based solution to this problem is based on a new formulation of the IBM translation models.

Consider a source French sentence f of |f| words f₁, f₂, fⱼ, . . . , an alignment â represented by α₁, α₂, α₃, . . . and a partial target sentence e comprising words e₁, e₂, . . . eᵢ, . . . Let φ(i) be the fertility of the English word eᵢ at target position i. Alignment â maps each of the source words fⱼ, j=1, . . . , m to a target position in the range [0 . . . , l]. A mapping ψ is defined from [0, . . . , l] to subsets of {1, . . . , m} as follows:
ψ(i)={j:jε{1, . . . , m}Λãⱼ=i}Vi=0, . . . , l.
where: ψ(i) is the set of source positions which are mapped to the target location i by the alignment ã and the fertility of the target position i is φᵢ=|ψ(i)|.
Each of the IBM models Pr(f,ã|e) can be rewritten as follows:

$$Pr ( f , \tilde{a} / e ) = ξ {\prod }_{i = l}^{l} {T}_{i} {D}_{i} {N}_{i} .$$

Table 1, below, shows breaking up of Pr(f, ã|e) into constituents Tᵢ, Dᵢ and N₁:

TABLE 1

| Model | ξ | Tᵢ | Dᵢ | Nᵢ |
|---|---|---|---|---|
| 1 | $\frac{ε ( m \vert l )}{{( l + 1 )}^{m}}$ | ${\prod }_{k ∈ ψ ( i )} t ( {f}_{k} \vert {e}_{i} )$ | 1 | 1 |
| 2 | ε(m\|l) | ${\prod }_{k ∈ ψ ( i )} t ( {f}_{k} \vert {e}_{i} )$ | ${\prod }_{k ∈ ψ ( i )} a ( i \vert k , m , l )$ | 1 |
| 3 | $n ( {ϕ}_{0} \vert m ) {p}_{o}^{m - 2 {ϕ}_{0}} {p}_{1}^{{ϕ}_{0}}$ | ${\prod }_{k ∈ ψ ( i )} t ( {f}_{k} \vert {e}_{i} )$ | ${\prod }_{k ∈ ψ ( i )} d ( k \vert i , m , l )$ | ${ϕ}_{i} \vert n ( {ϕ}_{i} \vert {e}_{i} )$ |

As a consequence, Pr(f, ã|e) Pr(e) can be written as:

$$Pr ( f , \tilde{a} / e ) Pr ( e ) = ξλ {\prod }_{i = l}^{l} {T}_{i} {D}_{i} {N}_{i} {L}_{i} .$$

where: Lᵢ=trigram (eᵢ|eᵢ₋₂, eᵢ₋₁), and
λ is the trigram probability of the boundary word.

The foregoing reformation of the optimization function of the decoding problem allows dynamic programming to be used for solving FIXED_ALIGNMENT_DECODING efficiently. Notably, each word eᵢ has only a constant number of candidates in the vocabulary. Therefore, the set of words eᵢ, . . . , eᵢ that maximises the LSH of the above optimization function can be found in O(m) time using the standard Dynamic Programming algorithm.

Computer Implementation of French to English Translation Decoder Embodiment

The algorithms have been implemented in the C++ computer programming language and executed on an IBM RS-6000 dual processor workstation with 1 GB of RAM. A French-English translation model (based on IBM Model 3) was built by training over a corpus of 100,000 sentence pairs from the Hansard corpus. The translation direction was from French to English. The English language model used for decoding was built by training over a corpus consisting of about 800 million words. The test sentences were divided into several classes based on length. There were 300 test French sentences in each of the length classes. Four algorithms were implemented, namely:
1.1 NaiveDecode,
1.2 AlignmentAlternatingSearch with l restricted to m,
2.1 NaiveDecode with l varying from m/2 to 2m, and
2.2 AlignmentAlternatingSearch.

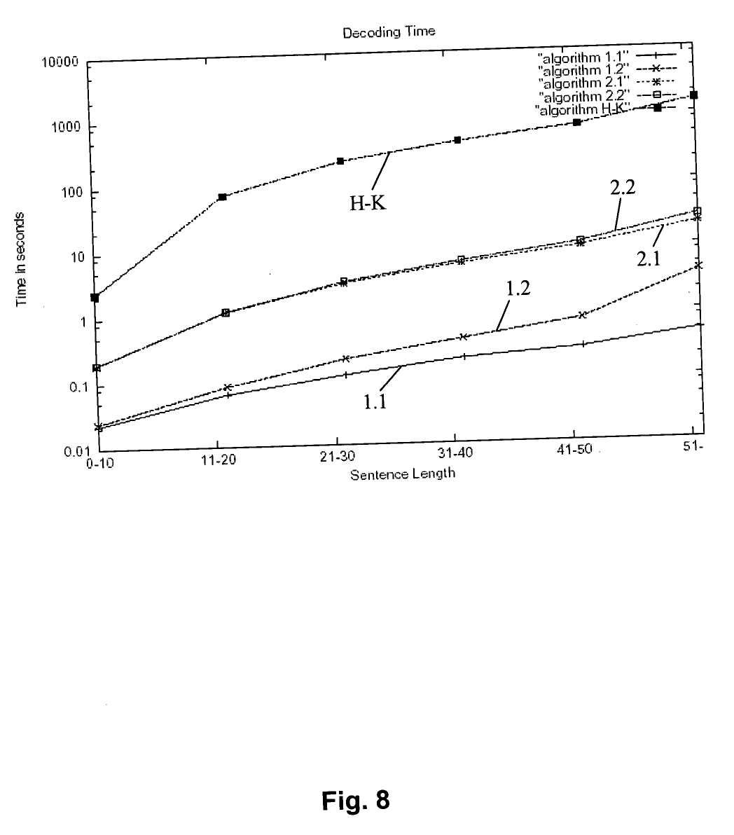

In order to provide comparative results, the dynamic programming based Held-Karp algorithm by Tillman (2001) was also implemented. Average times taken for translation of each length class were computed for each of the five algorithms and are shown in FIG. 8. The length class is shown on the x-axis. For example, the notation 11-20 indicates the class of sentences of length 11 to 20 words. Similarly, the notation 51+ indicates the class of sentences of length 51 words or more. Time is shown in seconds on a log scale as a function of sentence length.

The graph of FIG. 8 indicates that each of algorithms 1.1, 1.2, 2.1 and 2.2 are an order of magnitude faster than the Held-Karp algorithm and are able to translate even long sentences (51+ words) in a few seconds.

### GENERAL EMBODIMENT

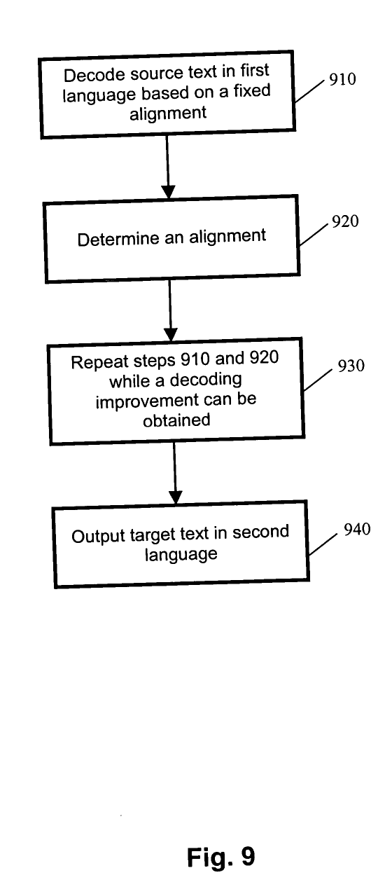

FIG. 9 is a flow diagram of a method for decoding or translating source language text into target language text.

At step 910, source text in a first language is decoded based on a fixed alignment between words in the source text and words in the target text. An alignment between words in the source text and words in the target text is determined at step 920. Either of steps 910 and 920 may be executed initially. If step 910 is executed first, an initial alignment may be guessed or estimated. Alternatively, if step 920 is executed first, an initial decoded text may be generated.

Steps 910 and 920 are repeated at step 930 while a decoding improvement in the target text can be obtained. Thereafter, the target text in a second language is output at step 940.

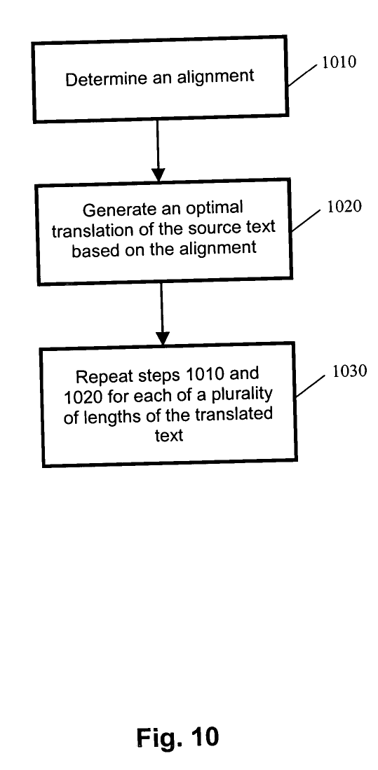

FIG. 10 is a flow diagram of another method for decoding or translating source language text into target language text.

At step 1010, an alignment between words in the source text and positions of words in the target text is determined. At step 1020, an optimal translation of the source text is generated based on the alignment determined in step 1010. At step 1030, steps 1010 and 1020 are repeated for each of a plurality of lengths of the translated text.

### Computer Hardware and Software

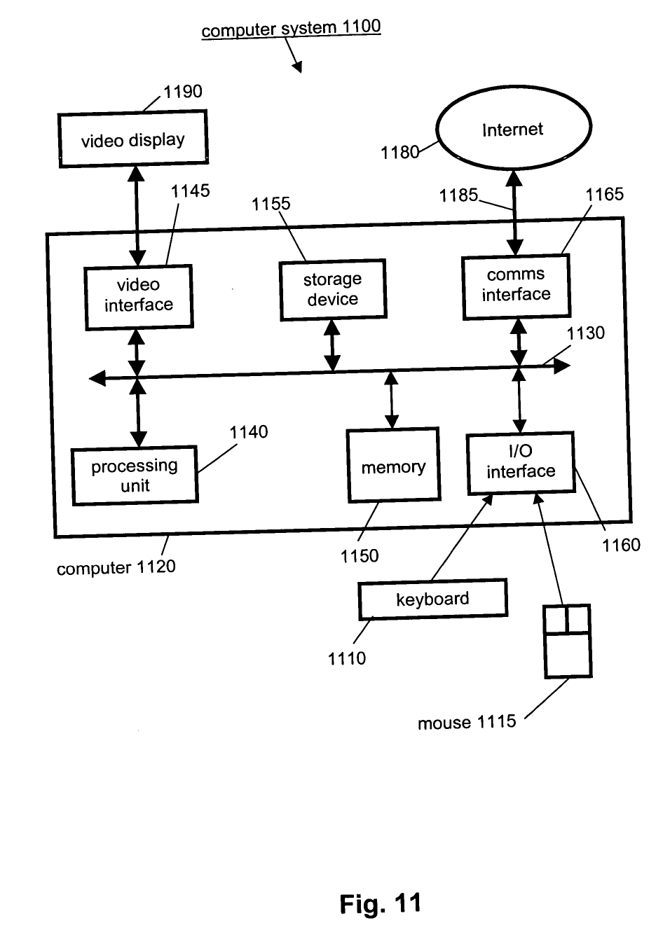

FIG. 11 is a schematic block diagram of a computer system 1100 that can be used to practice the methods and computer program products described hereinbefore and hereinafter. Specifically, the computer system 1100 is provided for executing computer software that is programmed to assist in performing a method for statistical translation decoding. The computer software executes under an operating system such as MS Windows XP™ or Linux™ installed on the computer system 1100.

The computer software involves a set of programmed logic instructions that may be executed by the computer system 1100 for instructing the computer system 1100 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program may be processed using a compiler into a binary format suitable for execution by the operating system. The computer program is programmed in a manner that involves various software components, or code means, that perform particular steps of the methods described hereinbefore.

The components of the computer system 1100 comprise: a computer 1120, input devices 1110, 1115 and a video display 1190. The computer 1120 comprises: a processing unit 1140, a memory unit 1150, an input/output (I/O) interface 1160, a communications interface 1165, a video interface 1145, and a storage device 1155. The computer 1120 may comprise more than one of any of the foregoing units, interfaces, and devices.

The processing unit 1140 may comprise one or more processors that execute the operating system and the computer software under control of the operating system. The memory unit 1150 may comprise random access memory (RAM), read-only memory (ROM), flash memory and/or any other type of memory known in the art for use under direction of the processing unit 1140.

The video interface 1145 is connected to the video display 1190 and provides video signals for display on the video display 1190. User input to operate the computer 1120 is provided via the input devices 1110 and 1115, comprising a keyboard and a mouse, respectively. The storage device 1155 may comprise a disk drive or any other suitable non-volatile storage medium.

Each of the components of the computer 1120 is connected to a bus 1130 that comprises data, address, and control buses, to allow the components to communicate with each other via the bus 1130.

The computer system 1100 may be connected to one or more other similar computers via the communications interface 1165 using a communication channel 1185 to a network 1180, represented as the Internet.

The computer software program may be provided as a computer program product, and recorded on a portable storage medium. In this case, the computer software program is accessible by the computer system 1100 from the storage device 1155. Alternatively, the computer software may be accessible directly from the network 1180 by the computer 1120. In either case, a user can interact with the computer system 1100 using the keyboard 1110 and mouse 1115 to operate the programmed computer software executing on the computer 1120.

The computer system 1100 has been described for illustrative purposes. Accordingly, the foregoing description relates to an example of a particular type of computer system suitable for practicing the methods and computer program products described hereinbefore and hereinafter. Other configurations or types of computer systems can equally well be used to practice the methods and computer program products described hereinbefore and hereinafter, as would be readily understood by persons skilled in the art.

### CONCLUSION

Embodiments of methods, apparatuses and computer program products have been described hereinbefore for performing statistical translation decoding. The foregoing description provides exemplary embodiments only, and is not intended to limit the scope, applicability or configurations of the invention. Rather, the description of the exemplary embodiments provides those skilled in the art with descriptions for implementing an embodiment of the invention. Various changes may be made in the function and arrangement of elements without departing from the spirit and scope of the invention as set forth in the claims hereinafter.

1. A method for decoding source text in a first language to target text in a second language, said method comprising:
decoding said source text into an intermediate text portion based on a fixed alignment between words in said source text and words in said intermediate text portion;
determining an alignment between words in said source text and words in said intermediate text portion;
alternately repeating said steps of decoding said source text and determining an alignment while a decoding improvement in said intermediate text portion can be obtained; and
outputting said intermediate text portion as said target text.

2. The method of claim 1, comprising the further step of repeating said step of alternately repeating said steps of decoding said source text and determining an alignment, for each of a plurality of lengths of said intermediate text portion.

3. The method of claim 1, wherein said decoding step is first performed based on an initial alignment that maps words in said source text to word positions in said intermediate text portion.

4. The method of claim 1, wherein said decoded text comprises an optimal translation for a fixed alignment.

5. The method of claim 4, wherein said optimal translation is generated based on dynamic programming.

6. The method of claim 1, wherein said alignment comprises an improved alignment relative to a previous alignment.

7. The method of claim 6, wherein said alignment comprises an optimal alignment.

8. The method of claim 7, wherein optimal alignment is determined based on a Viterbi algorithm.

9. A method for translating source text in a first language to translated text in a second language, said method comprising:
determining an alignment between words in said source text and positions of words in said translated text;
generating an optimal translation of said source text based on said alignment;
repeatedly performing said steps of determining an alignment and generating an optimal translation for each of a plurality of lengths of said translated text.

10. An apparatus for decoding source text in a first language to target text in a second language, comprising:
a memory unit adapted for storing data and instructions; and
a processing unit coupled to said memory unit, said processing unit programmed to:
decode said source text into an intermediate text portion based on a fixed alignment between words in said source text and words in said intermediate text portion;
determine an alignment between words in said source text and words in said intermediate text portion;
alternately repeat said steps of decoding said source text and determining an alignment while a decoding improvement in said intermediate text portion can be obtained; and
output said intermediate text portion as said target text.

11. The apparatus of claim 10, wherein said processing unit is programmed to repeat alternately decoding said source text and determining an alignment, for each of a plurality of lengths of said intermediate text portion.

12. The apparatus of claim 11, wherein said processing unit is programmed to first decode said source text based on an initial alignment that maps words in said source text to word positions in said intermediate text portion.

13. The apparatus of claim 11, wherein said processing unit is programmed to optimally decode said source text for a fixed alignment.

14. The apparatus of claim 13, wherein said processing unit is programmed to optimally decode said source text using dynamic programming.

15. The apparatus of claim 11, wherein said processing unit is programmed to determine an improved alignment relative to a previous alignment.

16. The apparatus of claim 15, wherein said processing unit is programmed to determine an optimal alignment.

17. The apparatus of claim 16, wherein said processing unit is programmed to determine said optimal alignment using a Viterbi algorithm.

18. An apparatus for translating source text in a first language to translated text in a second language, comprising:
a memory unit adapted for storing data and instructions; and
a processing unit coupled to said memory unit, said processing unit programmed to:
determine an alignment between words in said source text and positions of words in said translated text;
generate an optimal translation of said source text based on said alignment; and
repeatedly perform said determining and generating steps for each of a plurality of lengths of said translated text.

19. A computer program product comprising a computer readable medium comprising a computer program recorded therein for decoding source text in a first language to target text in a second language, said computer program product comprising:
computer program code for decoding said source text into an intermediate text portion based on a fixed alignment between words in said source text and words in said intermediate text portion;
computer program code for determining an alignment between words in said source text and words in said intermediate text portion;
computer program code for repeatedly executing said computer program code for decoding said source text and determining an alignment while a decoding improvement in said intermediate text portion can be obtained; and
computer program code for outputting said intermediate text portion as said target text.

20. The computer program product of claim 19, further comprising computer program code for repeatedly executing said computer program code for decoding said source text and said computer program code for determining an alignment, for each of a plurality of lengths of said intermediate text portion.

21. The computer program product of claim 20, further comprising computer program code for determining an initial alignment that maps words in said source text to word positions in said intermediate text portion.

22. The computer program product of claim 20, wherein said computer program code for decoding comprises computer program code for optimally decoding said source text for a fixed alignment.

23. The computer program product of claim 22, wherein said computer program code for optimally decoding said source text is based on dynamic programming.

24. The computer program product of claim 20, wherein said computer program code for determining an alignment comprises computer program code for determining an improved alignment relative to a previous alignment.

25. The computer program product of claim 24, wherein said computer program code for determining an alignment comprises computer program code for determining an optimal alignment.

26. The computer program product of claim 6, wherein said computer program code for determining an optimal alignment comprises a Viterbi algorithm.

27. A computer program product comprising a computer readable medium comprising a computer program recorded therein for translating source text in a first language to translated text in a second language, said computer program product comprising:
computer program code means for determining an alignment between words in said source text and positions of words in said translated text;
computer program code means for generating an optimal translation of said source text based on said alignment; and
computer program code means for repeatedly performing said determining and generating steps for each of a plurality of lengths of said translated text.

28. A system for decoding source text in a first language to target text in a second language, said system comprising:
means for decoding said source text into an intermediate text portion based on a fixed alignment between words in said source text and words in said intermediate text portion;
means for determining an alignment between words in said source text and words in said intermediate text portion;
means for obtaining a decoding improvement in said intermediate text portion; and
means for outputting said intermediate text portion as said target text.
